(19) United States
(12) Patent Application Publication
(10) Pub. No.: US 2025/0104884 A1
(43) Pub. Date: Mar. 27, 2025

(54) CONDUCTIVE MEMBER AND METHOD FOR MANUFACTURING THIS CONDUCTIVE MEMBER

(71) Applicant: NATIONAL INSTITUTE OF ADVANCED INDUSTRIAL SCIENCE AND TECHNOLOGY, Tokyo (JP)

(72) Inventors: Junichi NOMOTO, Tsukuba-shi (JP); Iwao YAMAGUCHI, Tsukuba-shi (JP); Takashi KOIDA, Tsukuba-shi (JP); Tetsuo TSUCHIYA, Tsukuba-shi (JP)

(21) Appl. No.: 18/728,803

(22) PCT Filed: Jan. 17, 2023
(86) PCT No.: PCT/JP2023/001240

§ 371 Date: Jul. 12, 2024

(30) Foreign Application Priority Data
Jan. 17, 2022 (JP) 2022-005003

(51) Int. Cl. H01B 5/14; H01B 1/08; H01B 19/04

(52) U.S. Cl. CPC H01B 5/14; H01B 1/08; H01B 19/04

(57) ABSTRACT

A conductive member includes a substrate and a transparent conductive film formed on the substrate, the substrate is a non-heat-resistant substrate, the transparent conductive film contains crystalline particles containing indium oxide, and the mobility of carrier electrons is 70 cm²/V·s or more.

### TECHNICAL FIELD

The present invention relates to a conductive member and a method for manufacturing the conductive member.

Priority is claimed on Japanese Patent Application No. 2022-005003, filed Jan. 17, 2022, the content of which is incorporated herein by reference.

### BACKGROUND ART

Transparent conductive films are widely used for applications such as display electrodes of flat displays such as plasma displays (PDP), liquid crystal displays (LCD), field emission displays (FED), and organic electroluminescence displays (OLED), transparent electrodes of image display devices such as electronic paper, transparent electrodes for touch panels, transparent conductive window electrodes for solar cells, and heat-reflecting glass. In addition, along with rapid size reduction and weight reduction of portable mobile terminals in recent years, further weight reduction is required for substrates on which transparent electrodes are provided. Therefore, transparent polymer substrates, which are lighter than glass, are used as substrates on which transparent electrodes are provided.

When a transparent conductive film is used as a transparent electrode of a flat display, it is required to have low resistance and high transmittance of light mainly within a wavelength range of 400 nm to 800 nm. In such a display, a thin-film transistor substrate in which transparent conductive films are used as common electrodes and pixel electrodes is used.

As materials for transparent conductive films, ITO, which is formed by adding an appropriate amount of tin oxide to indium oxide having relatively excellent translucency in a visible region (mainly within a wavelength range of 400 nm to 800 nm) and low resistance, or IZO, which is formed by adding an appropriate amount of zinc oxide, is used.

In addition, due to the soaring price of indium oxide, alternative materials containing no indium oxide such as materials containing zinc oxide, titanium oxide, and tin oxide as main raw materials, metal nanowires, and graphene have been studied. However, in flat display applications, materials containing indium oxide as a main raw material are still mainly used as materials for transparent conductive films.

On the other hand, when a transparent conductive film is used as a transparent electrode of a solar cell, the transparent conductive film is required to have low resistance and high transmittance of light in a wavelength range of a sunlight spectrum, which mainly includes ultraviolet light with a wavelength of 400 nm to infrared light in a range of 1,400 nm. This is because, in the case of solar cells having a photoelectric conversion layer that has spectral sensitivity up to the near-infrared wavelength range or laminated solar cells in which photoelectric conversion layers with different spectral sensitivities are laminated, when a transparent conductive film having translucency in a wavelength range narrower than spectral sensitivity of the photoelectric conversion layer is used as a window material, a decrease in transmission of light to the power generation layer is caused, and as a result, a decrease in power generation efficiency is caused.

In addition, sunlight contains infrared light with a wavelength up to 2,500 nm, and in order to utilize as much sunlight energy as possible, development of solar cells that operate at longer wavelengths is required, and a transparent conductive film with high transmittance at longer wavelengths is also required.

In addition, transparent conductive films with high infrared transmittance are required for optical communication device applications in which a wavelength of 1,550 nm is used and for infrared sensor applications.

Generally, when light enters a substance, some of the light is reflected or absorbed within the substance, and the remainder is transmitted. The transparent conductive material is a degenerate n-type semiconductor, and electrons as carriers contribute to electrical conduction. In addition, electrons as carriers reflect and absorb light with a certain wavelength or more. The wavelength of the light is defined by the plasma frequency: wₚ=√(Ne²/(m*ε)) (N: carrier density, e: elementary charge, m*: effective mass of electrons, ε: dielectric constant), depends on the carrier density, and is generally within a near-infrared region. For example, the generally used ITO thin film has a carrier density of about 1×10²¹ cm⁻³ and a very low resistivity of 2×10⁻⁴ Ω·cm, but, for example, as shown in Non-Patent Document 1, infrared light with a wavelength of 1,000 nm or more is absorbed or reflected, and hardly passes through.

In addition, generally, the resistivity of a substance is defined by 1/(Ne*μ) (μ: mobility), and is inversely proportional to the product of the carrier density and the carrier mobility. Therefore, in order to increase infrared transmittance, it is sufficient to decrease the carrier density, but it is necessary to increase the mobility in order to decrease the resistivity.

The mobility of a low-resistance oxide conductive film formed of a conventional material is about 20 to 30 cm²/V·s for an ITO film, for example, as reported in Non-Patent Document 1. The mobility of the thin film with a carrier density of 1×10¹⁹ cm⁻³ or more is mainly controlled by ionized impurities and neutral impurity scattering. Here, examples of ionized impurities in the ITO thin film include, in addition to tin ions as additives, point defects such as oxygen vacancies and interstitial indium, or complex defects involving them. As the amount of impurities added to increase the carrier density increases, the mobility decreases due to the influence of ionized impurity scattering.

During ITO film formation, when the amount of oxygen introduced increases, it is possible to reduce the amount of oxygen vacancies and improve near-infrared transmittance. However, in this method, the amount of neutral impurities increases, resulting in a decrease in mobility and an increase in resistivity.

It is known that a carrier mobility of 80 cm²/V's or more is obtained when an appropriate amount of titanium oxide, zirconium oxide, and molybdenum oxide is added to indium oxide as in Non-Patent Documents 2 to 4, and when an appropriate amount of tungsten oxide is added to indium oxide as in Non-Patent Document 5.

On the other hand, in formation of these films, since heating is required during film formation, when an inorganic substrate such as a glass substrate is used as a substrate, it is possible to perform manufacturing, but when a polymer substrate is used, it is difficult to perform manufacturing because problems related to heat resistance of the substrate such as deformation and discoloration occur. Therefore, as shown in Non-Patent Document 6, when polyethylene terephthalate (PET) is used as a polymer substrate, the obtained carrier mobility is 61.6 cm²/V·s when tungsten oxide is added to indium oxide.

Non-Patent Document 3 shows that, by adding an appropriate amount of hydrogen to indium oxide or co-adding appropriate amounts of hydrogen and tungsten oxide or cerium oxide, a carrier mobility of about 100 cm²/V·s or more is obtained. This film formation includes two steps, and when water vapor is introduced when a film is formed using indium oxide or indium oxide with tungsten oxide or cerium oxide added thereto at temperatures from room temperature to 100° C. or lower, there is an effect of preventing crystallization of the transparent conductive film during film formation, and a precursor film that is amorphous or contains a larger amount of amorphous components than polycrystalline components is formed. After the film is formed, high mobility is achieved by performing crystallization according to a heat treatment in air or a vacuum at a temperature exceeding 150° C., preferably at a temperature of 200° C. or higher.

Patent Document 1 discloses an example in which an indium oxide film with high mobility is formed on a film substrate. When formed on a polyethylene naphthalate or polyimide substrate, which is a film with high heat resistance, a mobility of 70 cm²/V·s or more is obtained by performing annealing at 170° C. or higher. However, a transparent conductive film with high mobility has not been achieved on a substrate that has a heat-resistance temperature of 150° C. or lower.

In order to increase the mobility of the transparent conductive film, it is better to have fewer grain boundaries serving as scattering centers and it is preferable to have a larger crystal grain size. Patent Document 2 discloses an example in which 1.4 μm crystal grains are formed on a film according to a heat treatment. However, there is no description of mobility, and the sheet resistance remains at 170Ω/□. In addition, in Patent Document 2, it is said that an object is to alleviate stress for peeling restriction and it is preferable to have a wide particle size distribution from small particle sizes to large particle sizes, and thus when the size exceeds 2,000 nm, this is not preferable because the durability against pen input deteriorates.

Patent Documents 3 and 4 disclose examples in which transparent conductive film crystals are formed by radiating light onto a polymer substrate. However, while microcrystals are obtained in Patent Document 3, the mobility is about 40 cm²/V·s. In Patent Document 4, an amorphous-free transparent conductive film is obtained using a lamp in combination with heating, but there is no disclosure regarding the state or mobility of crystal grains.

### CITATION LIST

### Patent Document

### Non-Patent Document

### [Non-Patent Document 1]

H. Fujiwara et al., Phys. Rev. B 71 (2005) 075109.

### [Non-Patent Document 2]

M. F. A. M. van Hest, et al., Appl. Phys. Lett., 87 (2005) 032111.

### [Non-Patent Document 3]

T. Koida et al., J. Appl. Phys., 101 (2007) 063713.

### [Non-Patent Document 4]

P. F. Newhouse, et al., Appl. Phys. Lett., 87 (2005) 112108.

### [Non-Patent Document 5]

T. Koida et al., Phys. Status Solidi A, 215 (2018) 1700506.

### [Non-Patent Document 6]

J.-G. Kim, et al., AIP Advances 8 (2018) 105122.

### Patent Document

### [Patent Document 1]

Japanese Patent No. 5510849

### [Patent Document 2]

Japanese Unexamined Patent Application, First Publication No. 2003-94552

### [Patent Document 3]

Japanese Unexamined Patent Application, First Publication No. 2020-77637

### [Patent Document 4]

Japanese Unexamined Patent Application, First Publication No. 2006-286308

### SUMMARY OF INVENTION

### Technical Problem

As described above, since heating is required to form a transparent conductive film with high carrier mobility, when an inorganic substrate such as a glass substrate is used as a substrate, it is possible to perform manufacturing, but when a polymer substrate is used, it is difficult to perform manufacturing because problems related to heat resistance of the substrate such as deformation and discoloration occur. Therefore, there is no report of a transparent conductive film having both low resistivity and high translucency in a wide wavelength range of mainly 400 nm to 1600 nm being manufactured on a polymer substrate.

The present invention has been made in view of the above circumstances, and an object of the present invention is to provide a conductive member having a transparent conductive film with excellent conductivity and high translucency, and a method for manufacturing the conductive member.

### Solution to Problem

A conductive member according to the present invention includes a substrate and a transparent conductive film formed on the substrate, and the transparent conductive film contains indium oxide crystallized and crystal-grown by light radiation. Light radiation is a means of promoting crystallization of the transparent conductive film in place of heating, and is an effective means for forming a crystalline transparent conductive film on a polymer substrate with poor heat resistance that goes through deterioration due to heating such as deformation, discoloration, and burning.

When crystallization of the transparent conductive film is promoted by light radiation, crystallization of the transparent conductive film is promoted on a low-heat-resistance substrate on which heating is restricted, and it is possible to improve characteristics of the transparent conductive film, that is, to lower the resistance due to an increase in carrier mobility of the transparent conductive film and improve the transmittance of the transparent conductive film. Therefore, a conductive member with excellent low resistance can be obtained without undergoing a high-temperature treatment.

The inventors conducted extensive studies in order to achieve the above object, and as a result, obtained a conductive member with high carrier mobility and high infrared transparency by promoting crystallization of a transparent conductive film by light radiation and forming crystalline particles with a large particle size on a low-heat-resistance substrate.

The present invention has been completed based on these findings, and according to the present invention, the following inventions are provided.

[1] A conductive member including a substrate and a transparent conductive film formed on the substrate,
wherein the substrate is a non-heat-resistant substrate, and
wherein the transparent conductive film contains crystalline particles containing indium oxide and has a carrier mobility of 70 cm²/V·s or more.

[2] The conductive member according to [1],
wherein the substrate is formed of a polymer material.

[3] The conductive member according to [1] or [2],
wherein the deterioration start temperature of the non-heat-resistant substrate is lower than 150° C.

[4] The conductive member according to any one of [1] to [3],
wherein, in the transparent conductive film,
the proportion of the crystalline particles determined from surface observation using an electron microscope is 90% or more.

[5] The conductive member according to any one of [1] to [4],
wherein, in the transparent conductive film, in surface observation using an electron microscope, a ratio of a total area of crystalline particles with a particle area of 0.5 μm² or more with respect to an observation area is 50% or more.

[6] The conductive member according to any one of [1] to [5],
wherein the indium oxide contains one or more selected from the group consisting of Ce, W, Ti, Zr and Mo as a doping component.

[7] The conductive member according to any one of [1] to [6],
wherein the resistivity of the transparent conductive film is 4×10⁻⁴ Ω·cm or less.

[8] The conductive member according to any one of [1] to [7],
wherein the sheet resistance of the transparent conductive film is 25Ω/□ or less.

[9] The conductive member according to any one of [1] to [8],
wherein one or more intermediate layers are provided between the substrate and the transparent conductive film.

[10] The conductive member according to any one of [1] to [9],
wherein the solar transmittance is 80% or more.

[11] The conductive member according to any one of [1] to [10],
wherein the transmittance in a wavelength band of 1,550 nm is 85% or more.

[12] The conductive member according to any one of [1] to [11], which is used for any one of a photoelectric conversion device, an organic EL device, a wearable device, a transparent TFT, a transparent heater, an infrared communication device and an infrared sensor.

[13] A method for manufacturing the conductive member according to any one of [1] to [12], including
a process of forming a precursor of the transparent conductive film on a non-heat-resistant substrate; and
a process of crystallizing the precursor by radiating light to the precursor of the transparent conductive film.

### Advantageous Effects of Invention

According to the present invention, it is possible to provide a conductive member having a transparent conductive film with low resistivity and high light transmittance.

The transparent conductive film of the present invention, in which crystallization is promoted by light radiation, has better transparency in the visible region and near-infrared region than ITO thin films of conventional materials. In addition, since the resistance of the transparent conductive film is low, the energy efficiency in photoelectric conversion elements and the like is improved. In particular, it has become possible to form a low-resistance transparent conductive film on a non-heat-resistant substrate, which was not possible in the related art, and it is expected to be applied to flexible devices and lightweight devices. In addition, since the film can be manufactured in a room temperature and atmospheric pressure process, it can be said to be a very industrially useful invention.

### BRIEF DESCRIPTION OF DRAWINGS

FIG. 1(a) is a cross-sectional view showing a schematic configuration of a conductive member according to the present embodiment, and FIG. 1(b) is a cross-sectional view showing a modification example of FIG. 1(a).

FIG. 2 is an image showing the correlation between a carrier density and a carrier mobility of transparent conductive films of Comparative Examples 1 to 3 and Examples 1 to 7.

FIGS. 3(a) to 3(f) show images of the results of surface SIM observation of conductive members obtained in Comparative Examples 1 to 3 and Examples 1, 3, and 4.

FIG. 4(a) to FIG. 4(d) show images of the results of surface EBSD observation of the conductive members obtained in Comparative Examples 2 and 3 and Examples 1 and 3.

FIG. 5 is a graph showing the results obtained by comparing the areas of crystalline particles in Comparative Examples 2 and 3 and Examples 1 to 3, and analyzing particle sizes according to a particle area frequency distribution.

FIG. 6 is a graph showing transmittance spectrums of the transparent conductive films obtained in Example 3 and Comparative Example 1.

### DESCRIPTION OF EMBODIMENTS

A conductive member according to an embodiment of the present invention will be described. Here, the present embodiment will be described in detail to allow better understanding of the spirit of the present invention, and does not limit the present invention unless otherwise specified.

### [Conductive Member]

FIG. 1 is a cross-sectional view showing a schematic configuration of a conductive member according to the present embodiment. As shown in FIG. 1(a), the conductive member of the present embodiment includes a substrate 1 and a transparent conductive film 3 formed on the substrate 1. That is, in the conductive member of the present embodiment, the transparent conductive film is formed on one surface (the upper surface in FIG. 1(a)) of the substrate. In addition, as shown in FIG. 1(b), an intermediate layer 2 may be provided between the substrate 1 and the transparent conductive film 3.

The substrate is a non-heat-resistant substrate. The non-heat-resistant substrate is a substrate that goes through deterioration due to heat applied during formation and/or crystallization of a transparent conductive film. In addition, deterioration due to heating means the occurrence of deformation such as warping and shrinkage of the substrate caused by heating. In addition, as the substrate of the present embodiment, a substrate having transparency is preferably used. When the conductive member is required to be lightweight and flexible, a flexible polymer substrate is preferably used as the substrate.

The non-heat-resistant substrate is formed of, for example, a polymer material. In this case, the material of the substrate is not particularly limited, and examples of polymer materials include acrylic resins, polyesters (polyethylene terephthalate (PET), polyethylene naphthalate (PEN)), polyacrylonitrile, polystyrene, liquid crystal polymers (LCP), polyether imide (PEI), and polycarbonate. The non-heat-resistant substrate may be composed of a single layer formed of any of these materials or may be a laminate in which a plurality of layers formed of any of these materials are laminated. In addition, the non-heat-resistant substrate may be a composite substrate in which functional elements to be described below are laminated on a heat-resistant substrate such as glass.

In addition, the non-heat-resistant substrate includes a laminate in which a non-heat-resistant substrate (second substrate) is laminated on a heat-resistant substrate (first substrate), and which is a non-heat-resistant substrate as a whole. For example, the non-heat-resistant substrate may be a composite substrate in which functional elements are laminated on a glass substrate such as quartz glass and borosilicate glass. Examples of such functional elements include solar power generation elements, and examples of solar power generation elements include a laminate having layers formed of a material having a perovskite crystal structure. Examples of halogenated perovskites include inorganic halogenated perovskites, organic halogenated perovskites, and mixed halogen perovskites. Since halogenated perovskite decomposes or deteriorates due to heating at, for example, about 170° C., the conductive member of the present invention also includes a configuration in which a transparent conductive film is formed on a layer formed of halogenated perovskite or a composite substrate having the layer.

The halogenated perovskite can be represented by the formula ABX₃. In the formula, A is, for example, one or more selected from among methylammonium (MA), formamidinium (FA), ethanediammonium (EA), isopropylammonium, dimethylammonium, guanidinium, piperidinium, pyridinium, pyrrolidinium, imidazolium, t-butylammonium, Na, K, Rb, and Cs. For example, B is one or more selected from among Pb, Sn, Ge, Cu, Sr, Ti, Mn, Bi, and Zn. X is one or more selected from among F, Cl, Br, and I.

In a non-heat-resistant substrate formed of a polymer material (hereinafter simply referred to as a polymer substrate), for example, the deterioration due to heating means that phase transformation from amorphous to crystalline phases occurs due to heating, and light transparency changes accordingly, and in a non-heat-resistant substrate containing the functional element, for example, the deterioration due to heating means that the function thereof is reduced by heating. As long as characteristics of the substrate are impaired by heating, there are no restrictions on other characteristics, and the present invention can be applied to a substrate formed of a known polymer material or a substrate containing a known functional element.

The deterioration start temperature of the non-heat-resistant substrate is not particularly limited, and is, for example, lower than 150° C., and may be 130° C. or lower or 120° C. or lower.

The thickness of the substrate is determined depending on the application of the conductive member, and is not particularly limited. When the substrate is a transparent substrate, the thickness of the substrate is not particularly limited as long as it does not impair the transparency of the substrate.

The thickness of the substrate is generally 20 μm to 2 mm, preferably 30 μm to 1 mm, and more preferably 50 μm to 500 μm.

The transparent conductive film of the present embodiment contains crystalline particles containing indium oxide and has a carrier mobility of 70 cm²/V·s or more. In order to further lower the resistivity, the carrier mobility is preferably 80 cm²/V·s or more, more preferably 90 cm²/V's or more, still more preferably 100 cm²/V·s or more, and particularly preferably 110 cm²/V·s or more.

The transparent conductive film is formed of, for example, a material whose main component is indium oxide (In₂O₃), which is an oxide of indium (In). The indium oxide (In₂O₃) may contain other elements as doping components. For example, indium oxide may contain at least one or more selected from the group consisting of Ce, W, Ti, Zr and Mo as a doping component. Specific examples of such materials include indium-cerium (ICO) oxide, indium-tungsten (IWO) oxide, indium-titanium (ITiO) oxide, indium-zirconium (IZrO) oxide, and indium-molybdenum (IMoO) oxide. The transparent conductive film may further contain hydrogen in addition to metal oxides such as indium oxide. Here, in addition to metal oxides such as indium oxide, zinc, gallium or the like may be mixed into the transparent conductive film. In addition, unavoidable impurities may be incorporated into the transparent conductive film.

The proportion of the doping component contained is not particularly limited as long as the function of the transparent conductive film is exhibited, and is appropriately determined depending on the main component and the doping component. Specifically, when the transparent conductive film is formed of an indium-cerium (ICO) oxide, the proportion of the doping component is preferably 1 to 3%. When the transparent conductive film is formed of an indium-tungsten (IWO) oxide, the proportion of the doping component is preferably 1 to 2%. When the transparent conductive film is formed of an indium-zirconium (IZrO) oxide, the proportion of the doping component is preferably 1 to 3%. When the transparent conductive film is formed of an indium-molybdenum (IMoO) oxide, the proportion of the doping component is preferably 1 to 3%.

The proportion of crystalline particles in the transparent conductive film can be determined from surface observation using an electron microscope. Using crystal orientation analysis using electron backscatter diffraction (EBSD) in combination, the proportion of the area containing crystalline particles within the range of an electron microscope observation image can be defined as a proportion of crystalline particles contained in the transparent conductive film. The proportion of crystalline particles determined from surface observation using an electron microscope is preferably 90% or more. When the proportion of crystalline particles is 90% or more, a high carrier mobility of 70 cm²/V's can be achieved in the transparent conductive film. In addition, in order to obtain a transparent conductive film with high carrier mobility, the proportion of crystalline particles is preferably higher and more preferably 95% or more.

The size of crystalline particles of the transparent conductive film is not particularly limited, and a larger size is preferable in order to achieve high electron mobility. The crystal grain size distribution of the transparent conductive film can be evaluated by crystal orientation analysis using electron backscatter diffraction (EBSD). In surface observation using an electron microscope, it is preferable to contain more crystalline particles with an area of 0.5 μm² or more observed in the microscope image, and the ratio of a total area of crystalline particles with a particle area of 0.5 μm² or more with respect to the observation area is preferably 50% or more, more preferably 60% or more, and still more preferably 70% or more.

The thickness of the transparent conductive film is not particularly limited, and is appropriately adjusted depending on the application, and is preferably, for example, 50 nm or more.

The resistivity of the transparent conductive film is measured by Hall effect measurement using the van der Pauw method. Together with the resistivity, the carrier density and the carrier mobility are also measured.

The resistivity of the transparent conductive film is preferably 4×10⁻⁴ Ω·cm or less and more preferably 3.5×10⁻⁴ Ω·cm or less.

The sheet resistance of the transparent conductive film is a value obtained by dividing the resistivity by the film thickness. When the resistivity of the transparent conductive film is 4×10⁻⁴ Ω·cm or less or the sheet resistance is 25Ω/□ or less, the transparent conductive film can be practically used for applications to various elements.

In order to further reduce a decrease in transmittance caused by carriers, the carrier density of the transparent conductive film is preferably 1.5×10²⁰ cm⁻³ to 3.5×10²⁰ cm⁻³, more preferably 1.7×10²⁰ cm⁻³ to 3.0 cm⁻³, and still more preferably 1.8×10²⁰ cm⁻³ to 2.5 cm⁻³.

The transparency of the transparent conductive film is defined by the visible light transmittance of the transparent conductive film.

The visible light transmittance of the transparent conductive film is preferably 70% or more and more preferably 80% or more.

When the visible light transmittance of the transparent conductive film is 70% or more, sufficient visibility can be secured in various applications of the transparent conductive film.

The visible light transmittance of the transparent conductive film is measured by a measurement method according to Japanese Industrial Standards: JIS-R-3106.

The solar transmittance of the transparent conductive film is preferably 70% or more and more preferably 80% or more. When the solar transmittance of the member including a substrate and a transparent conductive film in combination is 70% or more, sufficient energy efficiency can be secured in various applications of photoelectric conversion devices.

The solar transmittance of the transparent conductive film and the conductive member is measured by a measurement method according to Japanese Industrial Standards: JIS-R-3106.

In addition, the transmittance of the transparent conductive film in a wavelength band of 1,550 nm is preferably 85% or more.

In addition, as described above, one or more intermediate layers may be provided between the substrate and the transparent conductive film. When a substrate that goes through deterioration due to light radiation is used, using an intermediate layer is an effective means. For example, when a polymer substrate having poor heat resistance is used, the role of the intermediate layer is as follows. According to the findings by the inventors, when strong light is radiated to the transparent conductive film, the transparent conductive film absorbs the energy and generates heat. However, when all the light radiated to the transparent conductive film is not absorbed by the transparent conductive film as energy, the energy is transferred to the polymer substrate as heat, the polymer substrate is heated or decomposed, and shrinkage, deformation and the like occur. In addition, even when no deformation occurs, cracks may occur in the transparent conductive film due to the difference in thermal expansion coefficient between the transparent conductive film and the polymer substrate. The inventors have found a structure in which an appropriate intermediate layer is interposed between the polymer substrate and the transparent conductive film, and thus an increase in temperature of the polymer substrate when light is radiated decreases. For the intermediate layer, the configuration and formation method described in Japanese Unexamined Patent Application, First Publication No. 2020-77637 can be applied.

Regarding the intermediate layer, when light is radiated to a laminate having layers composed of a substrate, an intermediate layer and a precursor of a transparent conductive film to be described below in that order from the side of the precursor of the transparent conductive film, the intermediate layer formed of a material having an effect of preventing the substrate from being heated by the light is preferable.

When the entire conductive member is required to have transparency, a transparent material is preferably used as the intermediate layer.

The visible light transmittance of the substrate and the intermediate layer in combination is preferably 75% or more and more preferably 80% or more.

The visible light transmittance of the substrate and the intermediate layer in combination is measured by a measurement method according to Japanese Industrial Standards: JIS-R-3106.

In addition, in the configuration including the substrate and the intermediate layer in combination, the transmittance in a wavelength band of 1,550 nm is preferably 85% or more.

The thickness of the intermediate layer is determined in consideration of transparency, flexibility, the material of the intermediate layer, and the like, and is not particularly limited.

The thickness of the intermediate layer is generally 10 nm to 100 μm, preferably 20 nm to 1 μm, and more preferably 50 nm to 300 nm. If the thickness of the intermediate layer is too thin, when light is radiated to the member from the side of the transparent conductive film, the effect of preventing the substrate from being heated by the light is not sufficiently obtained, and the effect of reducing deterioration of the substrate due to heating becomes weak.

The intermediate layer preferably contains an oxide, nitride or oxynitride of at least one metal selected from the group consisting of silicon (Si), aluminum (Al), zirconium (Zr), yttrium (Y), cerium (Ce), indium (In), tin (Sn), zinc (Zn), strontium (Sr), titanium (Ti), magnesium (Mg), calcium (Ca) and barium (Ba). These metal oxides, nitrides and oxynitrides may contain other elements or may be a mixture. In addition, these metal oxides, nitrides and oxynitrides may be insulating or conductive. Examples of these metal oxides include silicon oxide (SiO₂), aluminum oxide (Al₂O₃), magnesium oxide (MgO), zirconium oxide (ZrO₂), yttrium oxide (Y₂O₃), cerium oxide (CeO₂), indium oxide (In₂O₃), tin oxide (SnO₂), zinc oxide (ZnO), strontium titanate (SrTiO₃), calcium titanate (CaTiO₃), barium titanate (BaTiO₃), calcium zirconate (CaZrO₃), and calcium stannate (CaSnO₃).

### [Method for Manufacturing Conductive Member]

A method for manufacturing a conductive member of the present embodiment includes, as necessary, a process of forming an intermediate layer on a substrate (hereinafter referred to as an “intermediate layer forming process”), a process of forming a precursor of a transparent conductive film on a non-heat-resistant substrate or an intermediate layer formed on the non-heat-resistant substrate (transparent conductive film forming process), and a process of crystallizing the precursor by radiating light to the precursor of the transparent conductive film (crystallization process).

### (Intermediate Layer Forming Process)

In the method for manufacturing a conductive member of the present embodiment, as necessary, an intermediate layer is formed on a non-heat-resistant substrate. When the intermediate layer is formed, in the subsequent light radiation process, an effect of preventing deformation and deterioration of the non-heat-resistant substrate, which may occur when there is no intermediate layer, or the occurrence of cracks caused by the difference in thermal expansion coefficient between the non-heat-resistant substrate and the transparent conductive film can be expected.

A method of forming (a film of) an intermediate layer on a non-heat-resistant substrate is not particularly limited, and for example, physical vapor deposition methods (PVD method) such as a vacuum vapor deposition method, a DC magnetron sputtering method, a high-frequency magnetron sputtering method, a high-frequency superimposed DC magnetron sputtering method, and an ion plating method, a chemical vapor deposition method in which raw materials are reacted and deposited (CVD method), and application methods such as a spray method, a spin coating method, a dip coating method, and a screen printing method are used. The ion plating method using DC arc discharge is a method in which, in a vacuum chamber, the material of the intermediate layer is provided as a vapor deposition source and sublimated by DC arc plasma, and atoms thereof are attached to (deposited on) one surface of the non-heat-resistant substrate. In addition, the sputtering method is a method in which, in a vacuum chamber, the material of the intermediate layer is provided as a target, ionized rare gas elements and the like collide with the surface of the target to eject atoms of the material of the intermediate layer, and the atoms are attached to (deposited on) one surface of the substrate.

The material of the intermediate layer preferably includes an oxide, nitride or oxynitride of at least one metal selected from the group consisting of the above silicon (Si), aluminum (Al), zirconium (Zr), yttrium (Y), cerium (Ce), indium (In), tin (Sn), zinc (Zn), strontium (Sr), titanium (Ti), magnesium (Mg), calcium (Ca) and barium (Ba).

### (Transparent Conductive Film Forming Process)

Next, a transparent conductive film is formed on a non-heat-resistant substrate or an intermediate layer deposited on the non-heat-resistant substrate.

A method of forming (a film of) a transparent conductive film is not particularly limited, and for example, physical vapor deposition methods (PVD method) such as a vacuum vapor deposition method, a DC magnetron sputtering method, a high-frequency magnetron sputtering method, a high-frequency superimposed DC magnetron sputtering method, and an ion plating method, a chemical vapor deposition method in which raw materials are reacted and deposited (CVD method), and application methods such as a spray method, a spin coating method, a dip coating method, and a screen printing method are used.

As an example, when a sputtering method is used, the target is formed of, for example, a material whose main component is indium oxide (In₂O₃), which is an oxide of indium (In). In addition, the indium oxide (In₂O₃) may contain other elements as doping components. For example, indium oxide may contain at least one or more selected from the group consisting of Ce, W, Ti, Zr and Mo as a doping component. Specific examples of such materials include indium-cerium (ICO) oxide, indium-tungsten (IWO) oxide, indium-titanium (ITiO) oxide, indium-zirconium (IZrO) oxide, and indium-molybdenum (IMoO) oxide.

As described above, the material of the transparent conductive film is formed of a material whose main component is indium oxide (In₂O₃), which is an oxide of indium (In). Indium oxide may contain one or more selected from the group consisting of Ce, W, Ti, Zr, and Mo as a doping component. In addition, the transparent conductive film may further contain hydrogen in addition to metal oxides such as indium oxide. For example, since hydrogen may be present in a chamber during film formation and may be incorporated into the transparent conductive film, hydrogen may be contained in the transparent conductive film. In addition, impurities contained in raw material pellets or targets may be incorporated into the transparent conductive film as unavoidable impurities.

### (Crystallization Process)

Next, light is radiated to a precursor of a transparent conductive film formed on a non-heat-resistant substrate or an intermediate layer to cause crystal growth of the precursor. In this case, it may be heated to the extent that the non-heat-resistant substrate does not deteriorate. In addition, the direction in which light is radiated is not particularly limited, and it is preferable to radiate light to a laminate having layers composed of a substrate and a precursor of a transparent conductive film from the side of the precursor of the transparent conductive film. When an intermediate layer is formed on the non-heat-resistant substrate, it is preferable to radiate light to a laminate having layers composed of a substrate, an intermediate layer and a precursor of a transparent conductive film from the side of the precursor of the transparent conductive film.

The light radiated to the transparent conductive film is not particularly limited, and for example, an ArF excimer laser with a wavelength of 193 nm, a KrF excimer laser with a wavelength of 248 nm, an XeCl excimer laser with a wavelength of 308 nm, ultraviolet light, visible light, and infrared light are used. Among these, ultraviolet light including an excimer laser is preferable because the energy of photons is high, and crystallization can be promoted when the transparent conductive film absorbs the energy of the light.

A light source for radiating light to the transparent conductive film is not particularly limited, and for example, an excimer lamp, an excimer laser, a YAG laser, a dye laser, a femtosecond laser, a high-pressure mercury lamp, a low-pressure mercury lamp, a microwave excited metal hydride lamp, a microwave excited mercury lamp, a flash lamp and the like are used.

The atmosphere in which light is radiated to the transparent conductive film is not particularly limited, and light may be radiated in air, a vacuum, oxygen gas, nitrogen gas, a rare gas, hydrogen, or a mixed atmosphere thereof. The atmosphere gas may be an airflow using a tube furnace or light may be radiated in a chamber with no flow.

Heating may be performed at the same time as radiation of light, and the temperature when light is radiated to the transparent conductive film does not necessarily have to be room temperature. Heating may be performed within a range in which no deformation or deterioration of the substrate occurs, and a temperature from room temperature to 100° C. is preferably used.

The intensity of light radiated to the transparent conductive film is preferably 20 mJ/cm² or more and more preferably 30 mJ/cm² or more.

When the intensity of light radiated to the transparent conductive film is 20 mJ/cm² or more, crystallization of the transparent conductive film is sufficiently promoted.

### EXAMPLES

The present invention will be described below in more detail with reference to examples, but the present invention is not limited to the following examples.

### Examples 1 to 4 and Comparative Examples 1 to 3

As a substrate, a polyethylene terephthalate (PET) substrate was prepared.

SiO₂ was deposited on the substrate using an RF magnetron sputtering device, and an intermediate layer formed of SiO₂ and with a thickness of 150 nm was formed. In addition, indium cerium oxide (ICO) was deposited on the intermediate layer using an ion plating device using DC arc plasma, and a transparent conductive film formed of ICO and with a thickness of 150 nm was formed. The composition of raw material pellets used in this case had a metal ratio of In:Ce=98:2 (Comparative Example 1).

As the crystallization process, the obtained transparent conductive films were radiated with 2,500 shots from a KrF excimer laser with a wavelength of 248 nm (Comparative Example 2), 5,000 shots (Comparative Example 3), 10,000 shots (Example 1), 12,500 shots (Example 2), 15,000 shots (Example 3), and 30,000 shots (Example 4) to obtain conductive members. The energy density of the KrF excimer laser was 40.0 mJ/cm². In addition, the repetition frequency of the KrF excimer laser was 50 Hz.

### Comparative Examples 4 and 5

A transparent conductive film was formed on a PET substrate in the same manner as in Comparative Example 1 to obtain a conductive member. The obtained conductive member was heated at 100° C. or 150° C. That is, heating was performed in place of laser radiation in Examples 1 to 4.

At a heating temperature of 100° C., no clear crystallization was confirmed by X-ray diffraction, and at a heating temperature of 150° C., the warpage of the conductive member was large.

### Examples 5 and 6

Conductive members were obtained in the same manner as in Examples 1 to 4 except that, in the crystallization process, under heating at 100° C., a KrF excimer laser was radiated with an intensity of 45 mJ/cm² and 15,000 shots (Example 5), and an intensity of 40 mJ/cm² and 30,000 shots (Example 6).

### Example 7

A conductive member was obtained by radiation with a KrF excimer laser in the same manner as in Example 3 except that the crystallization process was performed in an oxygen atmosphere under heating at 100° C.

The transparent conductive films and conductive members obtained in Examples 1 to 7 and Comparative Examples 1 to 3 were measured and evaluated by the following methods.

### (Confirmation of Change in Shape)

The change in shape of the obtained conductive member was observed with the naked eye. It was determined that there was no deterioration when no clear cracks were observed in the transparent conductive film and no warping of the member itself was observed. As a result, in Examples 1 to 7, no change in shape was observed in the conductive members, and no deterioration was confirmed.

### (Confirmation of Crystallization)

The transparent conductive films of the conductive members obtained in Examples 1 to 7 and Comparative Examples 1 to 5 were measured using an X-ray diffraction method. Those in which 222 diffraction originating from a bixbyite structure In₂O₃ appearing near 20-30.5° was observed according to X-ray diffraction measurement using CuKα rays were determined to be crystallized and shown as “O” in the crystallization (XRD) column in Table 1. As a result, it was confirmed that the transparent conductive films in Examples 1 to 7 were crystallized.

### (Measurement of Electrical Characteristics)

The resistivity, carrier density and carrier mobility of the transparent conductive films of the conductive members obtained in examples and comparative examples were measured as follows. The Hall effect was measured using a resistivity/Hall measurement system (ResiTest 8300, commercially available from Toyo Corporation), and the resistivity, carrier density and Hall mobility of the transparent conductive films were obtained. Here, the obtained Hall mobility was used as the carrier mobility. The Hall effect was not measured for Comparative Example 5 in which the member was warped.

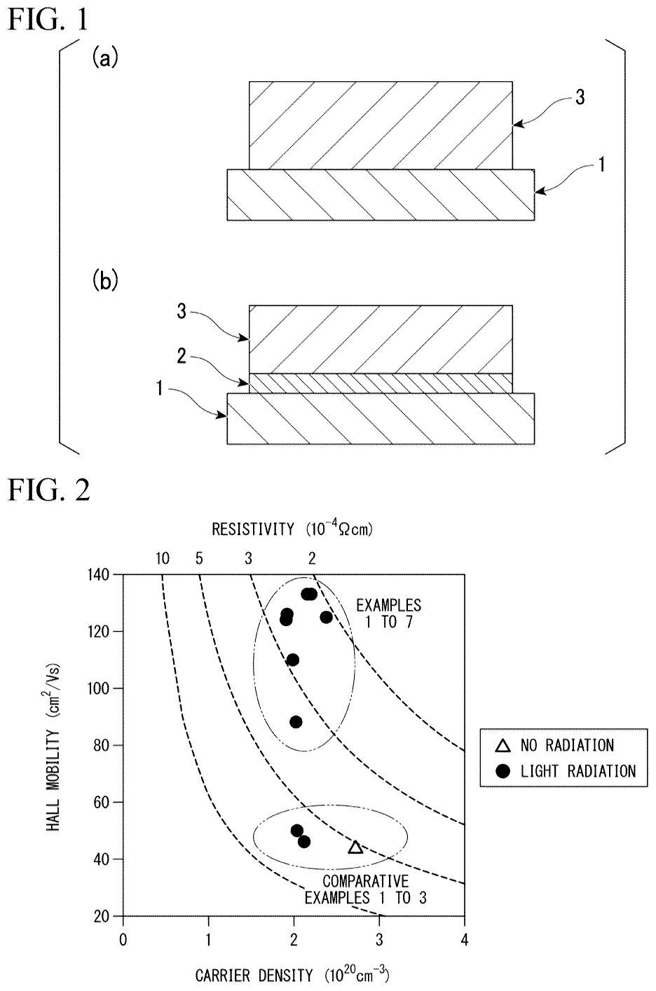

FIG. 2 is an image showing the correlation between the carrier density and the carrier mobility of the transparent conductive films of Comparative Examples 1 to 3 and Examples 1 to 7. In the drawing, curves with dashed lines represent lines of equal resistivity. Based on the results of FIG. 2, it was confirmed that, as the number of laser shots increased, the carrier mobility increased while the carrier density remained about 2×10²⁰ cm⁻³. In addition, it was confirmed that the resistivity decreased significantly as the carrier mobility increased. In Examples 2 to 7, the resistivity was 3×10⁻⁴ Ω·cm or less.

In addition, the sheet resistances of Comparative Examples 1 to 3 and Examples 1 to 7 were calculated. The sheet resistance was determined by measuring the resistivity of the transparent conductive film using the van der Pauw method and calculating the sheet resistance (resistivity/film thickness) indicating a practical resistance of the transparent conductive film, and it was determined that electrical characteristics were better as the value of the sheet resistance was lower. The results are shown in Table 1.

TABLE 1

| | | | | | | | | | | | | Carrier |
|---|---|---|---|---|---|---|---|---|---|---|---|---|
| | | Interme- | Transparent | | | Laser | | | Crystal- | Sheet | | mobility |
| | | diate | conductive | Atmo- | | intensity | Number | Shape | lization | resistance | Resistivity | (cm²/ |
| | Substrate | layer | film | sphere | Heating | (mJ/cm²) | of shots | change | (XRD) | (Ω/□) | (Ω · cm) | V · s) |
| Comparative | PET | SiO₂ | ICO | Air | No | No | 0 | No | x | 59 | 8.9E−04 | 42 |
| Example 1 | | | | | | | | | | | | |
| Comparative | PET | SiO₂ | ICO | Air | No | 40 | 2500 | No | x | 43 | 6.4E−04 | 46 |
| Example 2 | | | | | | | | | | | | |
| Comparative | PET | SiO₂ | ICO | Air | No | 40 | 5000 | No | ∘ | 41 | 6.2E−04 | 50 |
| Example 3 | | | | | | | | | | | | |
| Example 1 | PET | SiO₂ | ICO | Air | No | 40 | 10000 | No | ∘ | 23 | 3.5E−04 | 88 |
| Example 2 | PET | SiO₂ | ICO | Air | No | 40 | 12500 | No | ∘ | 19 | 2.8E−04 | 110 |
| Example 3 | PET | SiO₂ | ICO | Air | No | 40 | 15000 | No | ∘ | 18 | 2.6E−04 | 124 |
| Example 4 | PET | SiO₂ | ICO | Air | No | 40 | 30000 | No | ∘ | 17 | 2.6E−04 | 126 |
| Comparative | PET | SiO₂ | ICO | Air | 100° C. | No | 0 | No | x | 43 | 6.4E−04 | 43 |
| Example 4 | | | | | | | | | | | | |
| Comparative | PET | SiO₂ | ICO | Air | 150° C. | No | 0 | Warping | ∘ | — | — | — |
| Example 5 | | | | | | | | | | | | |
| Example 5 | PET | SiO₂ | ICO | Air | 100° C. | 45 | 15000 | No | ∘ | 15 | 2.2E−04 | 133 |
| Example 6 | PET | SiO₂ | ICO | Air | 100° C. | 40 | 30000 | No | ∘ | 14 | 2.1E−04 | 133 |
| Example 7 | PET | SiO₂ | ICO | Oxygen | 100° C. | 40 | 15000 | No | ∘ | 14 | 2.1E−04 | 125 |

Based on the results of Table 1, in Examples 1 to 7, a transparent conductive film was formed on a polymer substrate, and a sheet resistance of 25Ω/□ or less was achieved. Particularly, in Examples 2 to 7, a significantly low sheet resistance of 20Ω/□ or less was achieved. In Examples 1 to 7, the carrier mobility was 70 cm²/V·s or more. Particularly, in Examples 2 to 7, the carrier mobility was significantly high at 110 cm²/V·s or more. When the carrier mobility was 70 cm²/V's or more, sufficient transmittance of infrared light could be expected for application to photoelectric conversion elements.

### (Form and Particle Size of Crystalline Particles)

In the transparent conductive film of the conductive member, in order to clarify the cause of increase in carrier mobility, observation was performed using a scanning electron microscope (SEM) and a scanning ion microscope (SIM), crystal orientation analysis using electron backscatter diffraction (EBSD) was performed, and observation of forms of the crystalline particles and particle size analysis were performed.

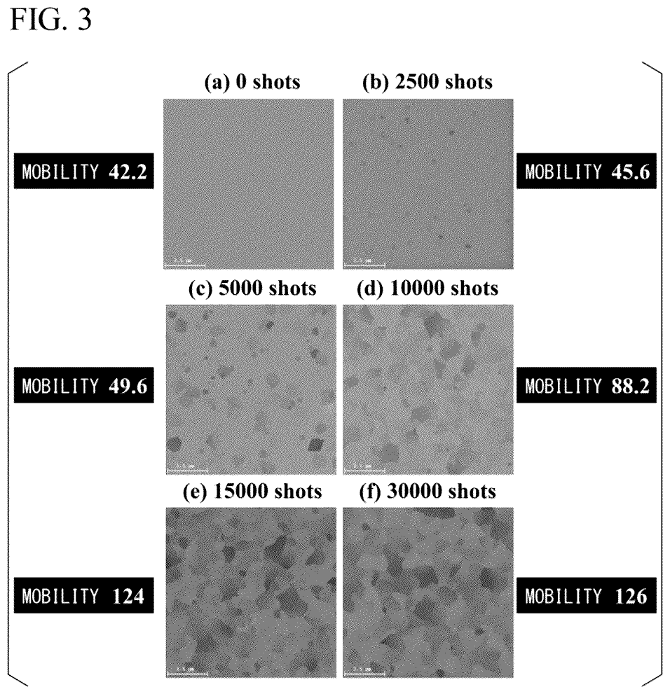

FIG. 3 shows images of the results of surface SIM observation of the conductive members of Comparative Examples 1 to 3 and Examples 1, 3, and 4. Before radiation with a KrF excimer laser, no crystallized particles were observed (Comparative Example 1: FIG. 3(a)). After laser radiation for 2,500 shots and 5,000 shots (Comparative Examples 2 and 3: FIG. 3(b), and FIG. 3(c)), crystalline particles were formed, but the proportion thereof was small. On the other hand, in examples in which a laser was radiated for 10,000 shots or more (Examples 1, 3, and 4: FIG. 3(d), FIG. 3(e), and FIG. 3(f)), it was confirmed that crystals were formed on almost the entire surface, including polygonal crystals with a crystal grain size of about 1 μm or more.

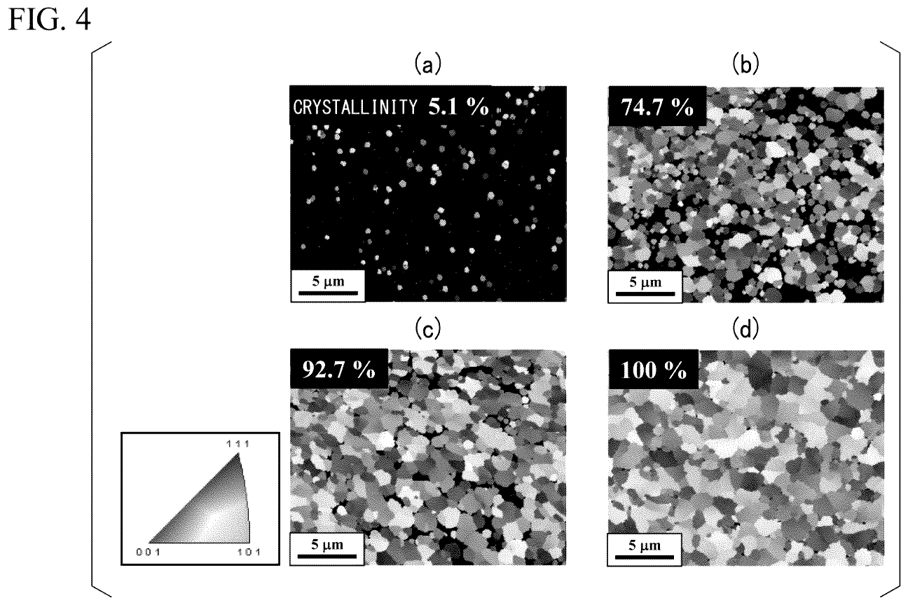

FIG. 4 shows images of the results of surface EBSD observation of the conductive members of Comparative Examples 2 and 3 and Examples 1 and 3. Based on the results of FIG. 4, it was confirmed that, after a KrF excimer laser was radiated, crystals were formed on almost the entire surface, including polygonal crystals with a crystal grain size of about 1 μm or more, compared to before a KrF excimer laser was radiated.

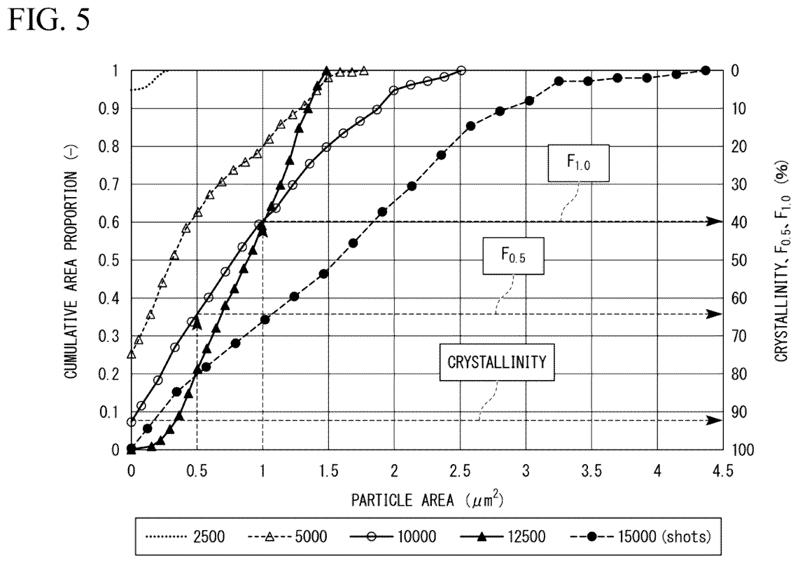

Crystal orientation analysis was performed from surface EBSD, and particle size analysis was performed. The ratio of the area of crystalline particles with respect to the observation area was defined as the crystallinity (%), that is, the ratio of crystalline particles. Here, particles with a diameter of about 0.08 μm or more, which is equal to or more than the measurement limit of EBSD, were recognized as crystalline particles. As shown in FIG. 5, the areas of crystalline particles in Comparative Examples 2 and 3 and Examples 1 to 3 were compared, and the particle sizes were analyzed as a particle area frequency distribution. As shown below, the area proportion (%) of crystalline particles with a particle area of 0.5 μm² or more was defined as F_{0.5}, and the area proportion (%) of particles of 1 μm² or more was defined as F_{1.0}.

F_{0.5}=a total area of particles with an area of 0.5 μm² or more/the total observation area×100(%)

F_{1.0}=a total area of particles with an area of 1.0 μm² or more/the total observation area×100(%)

In FIG. 5, as an example, the method of determining the crystallinity, F_{0.5}, and F_{1.0} in Example 1 is shown with a dashed line. The crystallinity, F_{0.5}, and F_{1.0} were determined by tracing vertically from the particle area of 0 μm², 0.5 μm², and 1.0 μm², respectively, tracing to the right from the point at which it intersected the cumulative area proportion curve, and reading the scale on the right axis.

In addition, the average particle size was determined using the equivalent area circular diameter assuming that each particle was a circle. The average particle size was determined to be the area average diameter using area weighting for only crystalline particles. Table 2 shows the crystallinity (%), F_{0.5} (%), F_{1.0} (%), and average particle size (μm) of Comparative Examples 2 and 3, and Examples 1 to 3.

TABLE 2

| | | | | | | | | Carrier | | | | |
|---|---|---|---|---|---|---|---|---|---|---|---|---|
| | | | Transparent | | | Laser | | mobility | | | | Average |
| | | Intermediate | conductive | | | intensity | Number | (cm²/ | Crystallinity | F_{0.5} | F_{1.0} | particle |
| | Substrate | layer | film | Atmosphere | Heating | (mJ/cm²) | of shots | V · s) | (%) | (%) | (%) | size (μm) |
| Comparative | PET | SiO₂ | ICO | Air | No | 40 | 2500 | 46 | 5 | 0 | 0 | 0.47 |
| Example 2 | | | | | | | | | | | | |
| Comparative | PET | SiO₂ | ICO | Air | No | 40 | 5000 | 50 | 75 | 38 | 20 | 0.87 |
| Example 3 | | | | | | | | | | | | |
| Example 1 | PET | SiO₂ | ICO | Air | No | 40 | 10000 | 88 | 93 | 64 | 40 | 1.07 |
| Example 2 | PET | SiO₂ | ICO | Air | No | 40 | 12500 | 110 | 100 | 79 | 41 | 0.90 |
| Example 3 | PET | SiO₂ | ICO | Air | No | 40 | 15000 | 124 | 100 | 80 | 66 | 1.37 |

Based on the results of Table 2, it was confirmed that when the crystallinity was 90% or more, the carrier mobility was high, reaching 80 cm²/V·s or more. In addition, it was confirmed that, as the crystalline particles were larger, the carrier mobility was higher, and as the proportion of large crystalline particles was higher, the carrier mobility was higher. Particularly, when the proportion of crystalline particles of 0.5 μm² or more was close to 80% (Examples 2 and 3), the carrier mobility was 100 cm²/V·s or more.

### (Measurement of Transmittance)

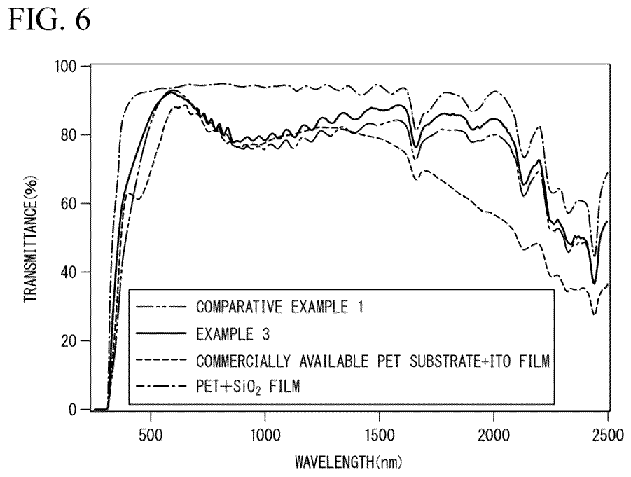

FIG. 6 shows transmittance spectrums of the transparent conductive films obtained in Example 3 and Comparative Example 1. For comparison, together, the transmittance spectrums of a PET/SiO₂ substrate and an ITO transparent conductive film on a commercially available PET substrate are also shown. The transmittance was obtained using a spectrophotometer (U4000, commercially available from Hitachi High-Tech Science Corporation).

As shown in FIG. 6, in Example 3, a transmittance of 75% or more was obtained at all wavelengths in a range of 800 nm to 2,000 nm, which is an infrared range. In addition, it was confirmed that the transmittance at a wavelength of 1,550 nm used for infrared communication was 83.7% in Comparative Example 1 and 87.7% in Example 3, and the transmittance was improved by crystallization of the transparent conductive film.

### (Solar Transmittance)

The solar transmittance was calculated by a method according to Japanese Industrial Standards: JIS-R-3106. The transmittance spectrum was multiplied by a weighting coefficient and weight-averaged to calculate a solar transmittance. The solar transmittance of the conductive member including the transparent conductive film of Example 3 was 82.3%, indicating a high solar transmittance.

The average light transmittance in a wavelength range of 800 nm to 2,000 nm was calculated as follows. In the same manner as computation of the solar transmittance, based on JIS-R-3106, the average light transmittance was computed by multiplying it by a weighting coefficient and weighted-averaged. The average light transmittance in a wavelength range of 800 nm to 2,000 nm was a high value of 81.6%.

### Example 8

As a substrate, a polyethylene terephthalate (PET) substrate was prepared.

SiO₂ was deposited on the substrate using an RF magnetron sputtering device, and an intermediate layer formed of SiO₂ and with a thickness of 150 nm was formed. In addition, indium oxide (In₂O₃) was deposited on the intermediate layer using an RF magnetron sputtering device, and a transparent conductive film formed of In₂O₃ and with a thickness of 150 nm was formed. In this case, an In₂O₃ sintered component was used as a sputter target.

In the crystallization process, the obtained transparent conductive film was radiated with 100,000 shots from a KrF excimer laser with a wavelength of 248 nm to obtain a conductive member. The energy density of the KrF excimer laser was 45.0 mJ/cm². In addition, the repetition frequency of the KrF excimer laser was 50 Hz.

The resistivity, carrier density, and carrier mobility of the transparent conductive film obtained in Example 8 were measured before and after a KrF excimer laser was radiated. As a result, the resistivity of the transparent conductive film was 4.2×10⁻⁴ Ω·cm before a KrF excimer laser was radiated, but it decreased to 3.4×10⁻⁴ Ω·cm after a KrF excimer laser was radiated. The carrier density was 5.0×10²⁰ cm⁻³ before a KrF excimer laser was radiated, but it decreased to 2.3×10²⁰ cm⁻³ after a KrF excimer laser was radiated. The carrier mobility was 29 cm²/V·s before a KrF excimer laser was radiated, but it increased to 80 cm²/V·s after a KrF excimer laser was radiated.

The transmittance spectrum of the transparent conductive film obtained in Example 8 was measured. The transmittance was obtained using a spectrophotometer (U4000, commercially available from Hitachi High-Tech Science Corporation).

In Example 8, the transmittance at a wavelength of 1,550 nm used for infrared communication was 81.4%.

Based on the above results of examples and comparative examples, it was confirmed that, when a transparent conductive film containing crystalline particles containing indium oxide was formed on a non-heat-resistant substrate by laser radiation under heating at 100° C. or lower, a transparent conductive film with a high carrier mobility of 70 cm²/V's or more was obtained. In addition, it was confirmed that the carrier density was about 2×10²⁰ cm⁻³ and a low value, a decrease in transmittance caused by carriers was alleviated, and a transmittance in a wide range of 300 nm to 2,500 nm was improved.

### INDUSTRIAL APPLICABILITY

Since the conductive member of the present invention includes a transparent conductive film having both high conductivity and high translucency, it is useful as a conductive member used for electrical and electronic devices such as photoelectric conversion devices, organic EL devices, wearable devices, transparent TFTs, transparent heaters, infrared communication devices, and infrared sensors.

1. A conductive member comprising a substrate and a transparent conductive film formed on the substrate,
wherein the substrate is a non-heat-resistant substrate, and
wherein the transparent conductive film contains crystalline particles containing indium oxide and has a carrier mobility of 70 cm²/V's or more.

2. The conductive member according to claim 1,
wherein the substrate is formed of a polymer material.

3. The conductive member according to claim 1,
wherein the deterioration start temperature of the non-heat-resistant substrate is lower than 150° C.

4. The conductive member according to claim 1,
wherein, in the transparent conductive film,
the proportion of the crystalline particles determined from surface observation using an electron microscope is 90% or more.

5. The conductive member according to claim 1,
wherein, in the transparent conductive film, in surface observation using an electron microscope, a ratio of a total area of crystalline particles with a particle area of 0.5 μm² or more with respect to an observation area is 50% or more.

6. The conductive member according to claim 1,
wherein the indium oxide contains one or more selected from the group consisting of Ce, W, Ti, Zr and Mo as a doping component.

7. The conductive member according to claim 1,
wherein the resistivity of the transparent conductive film is 4×10^{-4 22}·cm or less.

8. The conductive member according to claim 1,
wherein the sheet resistance of the transparent conductive film is 25Ω/□ or less.

9. The conductive member according to claim 1,
wherein one or more intermediate layers are provided between the substrate and the transparent conductive film.

10. The conductive member according to claim 1,
wherein the solar transmittance is 80% or more.

11. The conductive member according to claim 1,
wherein the transmittance in a wavelength band of 1,550 nm is 85% or more.

12. The conductive member according to claim 1, which is used for any one of a photoelectric conversion device, an organic EL device, a wearable device, a transparent TFT, a transparent heater, an infrared communication device and an infrared sensor.

13. A method for manufacturing the conductive member according to claim 1, comprising:
a process of forming a precursor of the transparent conductive film on a non-heat-resistant substrate; and
a process of crystallizing the precursor by radiating light to the precursor of the transparent conductive film.
